(19) United States
(12) Patent Application Publication
(10) Pub. No.: US 2015/0353396 A1
(43) Pub. Date: Dec. 10, 2015

(54) MULTI-STAGE IMMERSION-TYPE MEMBRANE SEPARATION DEVICE AND MEMBRANE SEPARATION METHOD

(71) Applicant: TORAY INDUSTRIES, INC., Chuo-ku, Tokyo (JP)

(72) Inventors: Hiroo TAKABATAKE, Otsu-shi, Shiga (JP); Jihoon CHEON, Iyo-gun, Ehime (JP); Aya NISHIO, Otsu-shi, Shiga (JP)

(73) Assignee: Toray Industries, Inc., Chuo-ku, Tokyo (JP)

(21) Appl. No.: 14/655,527

(22) PCT Filed: Dec. 25, 2013
(86) PCT No.: PCT/JP2013/084754

§ 371 Date: Jun. 25, 2015

(30) Foreign Application Priority Data
Dec. 26, 2012 (JP) 2012-283468

(51) Int. Cl. C02F 3/12; B01D 63/08; B01D 65/08; B01D 61/12

(52) U.S. Cl. CPC C02F 3/1273; B01D 61/12; B01D 63/082; B01D 65/08; B01D 2311/00; B01D 2319/02; C02F 2303/20; C02F 2209/40

(57) ABSTRACT

The present invention provides a submerged type membrane separation device and a membrane separation method which allow long-term stable filtration. In the submerged type membrane separation device including a membrane module having membrane units stacked on top of each other in stages, in each of which flat sheet membrane elements each having a separation membrane are arranged, the membrane module is constructed of various membrane units differing in sludge-filtration resistance or pure-water permeation resistance, whereby it becomes possible to extend a device operation period of time lapsing before transmembrane plugging occurs, or equivalently, the necessity to clean membranes arises. Further, it also becomes possible to design to synchronize timings with which a plurality of membrane units require cleaning.

### CROSS REFERENCE TO RELATED APPLICATIONS

This is the U.S. National Phase application of PCT/JP2013/084754, filed Dec. 25, 2013, which claims priority to Japanese Patent Application No. 2012-283468, filed Dec. 26, 2012, the disclosures of these applications being incorporated herein by reference in their entireties for all purposes.

### FIELD OF THE INVENTION

The present invention relates to a multi-stage submerged type membrane separation device in which separation between water and sludge is performed through the use of filtration separation membranes at the occasion of clarification of sewage and industrial effluent, and relates to a membrane separation method using such a membrane separation device.

### BACKGROUND OF THE INVENTION

As to means of clarifying sewage and industrial effluent, there have been known a method of giving enzymes to microorganisms in effluent, a method of mixing water into activated sludge and then performing separation treatment (a membrane bioreactor method, an MBR method for short) and so on. In the membrane bioreactor method in which activated sludge is separated into solids and liquid by the use of separation membranes each having a plurality of pores, the activated sludge is filtrated while the separation membrane surface is cleaned with an air-liquid mixture flow generated in a vertical direction by aeration from beneath the separation membranes for the purpose of suppressing “fouling”, a phenomenon that plugging of the separation membranes is caused by accumulation of activated-sludge components on the separation membrane surface. As an example of a membrane separation device usable in such a membrane bioreactor method, a multi-stage membrane separation device having a plurality of membrane cases (membrane units) stacked vertically in stages has been proposed (Patent Document 1).

However, the multi-stage membrane separation device having a plurality of membrane units superposed on top of each other is great in depth of water as compared with a single-stage membrane separation device, and there is therefore a tendency that air bubbles generated at the lowermost part are small in size owing to hydraulic pressure and gradually grow to larger sizes while moving upward. The membrane surface cleaning power generated by an air-liquid mixture flow becomes higher in response to increase in sizes of air bubbles, and hence air-diffusion cleaning effect is apt to become lower in the membrane unit placed at the lowermost stage than in membrane units placed at the other stages and is apt to become higher in the membrane unit placed at the upper stages. Thus, a lower-stage membrane unit having a relatively small effective area tends to suffer clogging (fouling) at the earlier time. Although the fouled membrane unit requires making a performance recovery by being taken out of the tank and cleaned or replaced with a new one, work for the performance recovery becomes complicated e.g. because even upper-stage membrane units have to be taken out. Accordingly, it has been a problem to reduce the frequency of taking out and cleaning membrane units by preventing the plugging of lower-stage membrane units to the utmost extent.

With this being the situation, a method of operating a multi-stage submerged type membrane separation device has been proposed which aimed at simplification of replacement work by designing membranes so that the higher their positions to be placed, they can permeate water at the higher flow rates, whereby the progression of contamination of upper-stage membranes is made faster than that of lower-stage membranes and the periodicity in plugging of upper-stage and lower-stage membranes can be synchronized (Patent Document 2).

### PATENT DOCUMENT

Patent Document 1: JP-A-10-334835

Patent Document 2: Japanese Patent No. 3659833

### SUMMARY OF THE INVENTION

The foregoing traditional multi-stage submerged type membrane separation device still has room for improvement in order to work the filtration membranes incorporated therein for a longer time.

Therefore the invention aims to provide a multi-stage submerged type membrane separation device capable of performing filtration with stability for a longer time.

By having made intensive studies in view of the foregoing situation, the present inventors have found that, in a multi-stage submerged type membrane separation device, installation of a membrane module constructed by the use of membrane units differing in filtration resistance allows extension of an operation period of time lapsing before transmembrane plugging occurs, or equivalently, the necessity to clean membranes arises, and at the same time, makes it possible to adjust the timing of membrane cleaning so that a plurality of membrane units become identical in the cleaning timing, thereby having come to achieve the invention.

Namely, the present invention relates to the following items <1> to <8>.
<1> A multi-stage submerged type membrane separation device including:

a membrane module having a plurality of membrane units stacked vertically in stages, in each of which a plurality of flat sheet membrane elements each having a sheet-shaped separation membrane are arranged;

a water-to-be-treated storage tank in which water to be treated is stored and the membrane module is placed in a state of being submerged in the water to be treated; and

an air diffuser installed beneath the membrane module,

in which the membrane unit placed at the lowermost stage is lower in sludge-filtration resistance or pure-water permeation resistance than any of the membrane units placed at stages higher than the membrane unit placed at the lowermost stage.
<2> The multi-stage submerged type membrane separation device according to <1>, in which the membrane unit placed at the lowermost stage is at least 10% lower in sludge-filtration resistance or pure-water permeation resistance than any other membrane units.
<3> The multi-stage submerged type membrane separation device according to <1> or <2>, in which the membrane unit placed at the lowermost stage is greater in number of the flat sheet membrane elements installed therein than the any of the membrane units placed at stages higher than the membrane unit placed at the lowermost stage.
<4> The multi-stage submerged type membrane separation device according to any one of <1> to <3>, in which each of the membrane units has a permeate pipeline communicating therewith and sending permeate having passed through the separation membrane, and

the permeate pipeline communicating with the membrane unit placed at the lowermost stage in the membrane module is connected to the permeate pipeline communicating with the any of the membrane units placed at stages higher than the membrane unit placed at the lowermost stage.
<5> The multi-stage submerged type membrane separation device according to <4>, in which a permeate flow rate in the membrane unit placed at the lowermost stage and a permeate flow rate in the any of the membrane units which is placed at a stage higher than the membrane unit placed at the lowermost stage and communicates with the permeate pipeline connected to the permeate pipeline communicating with the membrane unit placed at the lowermost stage are each controlled so that a transmembrane pressure difference of the membrane unit placed at the lowermost stage is almost equalized with a transmembrane pressure difference of the any of the membrane units.
<6> The multi-stage submerged type membrane separation device according to any one of <1> to <5>, in which each of the membrane units has a permeate pipeline communicating therewith and sending permeate having passed through the separation membrane, and

the device further includes a flow rate control means capable of independently controlling a flow rate of permeate sent through the permeate pipeline communicating with the membrane unit placed at the lowermost stage in the membrane module and a flow rate of permeate sent through the permeate pipeline communicating with the any of the membrane units placed at a stage higher than the membrane unit placed at the lowermost stage.
<7> A membrane separation method using a multi-stage submerged type membrane separation device which includes: a membrane module having a plurality of membrane units stacked vertically in stages, in each of which a plurality of flat sheet membrane elements each having a sheet-shaped separation membrane are arranged; a water-to-be-treated storage tank in which water to be treated is stored and the membrane module is placed in a state of being submerged in the water to be treated; and an air diffuser installed beneath the membrane module, in which the membrane unit placed at the lowermost stage is lower in sludge-filtration resistance or pure-water permeation resistance than any of the membrane units placed at stages higher than the membrane unit placed at the lowermost stage.
<8> The membrane separation method according to <7>, in which a flow rate of permeate passing through the separation membrane of the membrane unit placed at the lowermost stage in the membrane module is controlled so as to become lower than a flow rate of permeate passing through the separation membrane of the any of the membrane units placed at a stage higher than the membrane unit placed at the lowermost stage, and controlled so that a difference between these flow rates becomes 10% or below.

According to embodiments of the invention, a membrane unit low in sludge-filtration resistance or pure-water permeation resistance is placed at the lowermost stage of a membrane module, whereby it becomes possible to prolong a device operation time lapsing by the time when membranes get plugged, or equivalently, the membrane unit requires cleaning. Additionally, the plugging times of a plurality of membrane units are controlled so that they are synchronized. Thus it has become possible to achieve highly efficient maintenance of the device.

### BRIEF DESCRIPTION OF THE DRAWINGS

FIG. 1 is a perspective view showing a multi-stage submerged type membrane separation device according to an embodiment of the invention.

FIG. 2 is a schematic diagram illustrating a multi-stage submerged type membrane separation system according to one embodiment of the invention.

FIG. 3 is a schematic diagram illustrating a multi-stage submerged type membrane separation system according to another embodiment of the invention.

FIG. 4 is a perspective view showing two flat sheet membrane elements adjacent to each other in the interior of a membrane unit

FIG. 5 is a schematic diagram illustrating a membrane permeability resistance measurement apparatus.

FIG. 6 is a graph drawn from results of long-duration stable operation testing, in which changes in filtration pressure difference in Example 1 are shown.

FIG. 7 is a graph drawn from results of long-duration stable operation testing, in which changes in filtration pressure difference in Example 2 are shown.

FIG. 8 is a graph drawn from results of long-duration stable operation testing, in which changes in filtration pressure difference in Example 3 are shown.

FIG. 9 is a graph drawn from results of long-duration stable operation testing, in which changes in filtration pressure difference in Example 4 are shown.

FIG. 10 is a graph drawn from results of long-duration stable operation testing, in which changes in filtration pressure difference in Example 5 are shown.

FIG. 11 is a graph drawn from results of long-duration stable operation testing, in which changes in filtration pressure difference in Example 6 are shown.

FIG. 12 is a graph drawn from results of long-duration stable operation testing, in which changes in filtration pressure difference in Example 7 are shown.

FIG. 13 is a graph drawn from results of long-duration stable operation testing, in which changes in filtration pressure difference in Comparative Example 1 are shown.

FIG. 14 is a graph drawn from results of long-duration stable operation testing, in which a change in quantity of filtrated flow and changes in filtration pressure difference in Example 8 are shown.

FIG. 15 is a graph drawn from results of long-duration stable operation testing, in which a change in quantity of filtrated flow and change in filtration pressure difference in Comparative Example 2 are shown.

### DETAILED DESCRIPTION OF EMBODIMENTS OF THE INVENTION

The invention will now be explained in more detail, but the invention should not be construed as being limited to the following embodiments. And in carrying out the invention, changes and modifications can be arbitrarily made without departing from the gist of the invention.

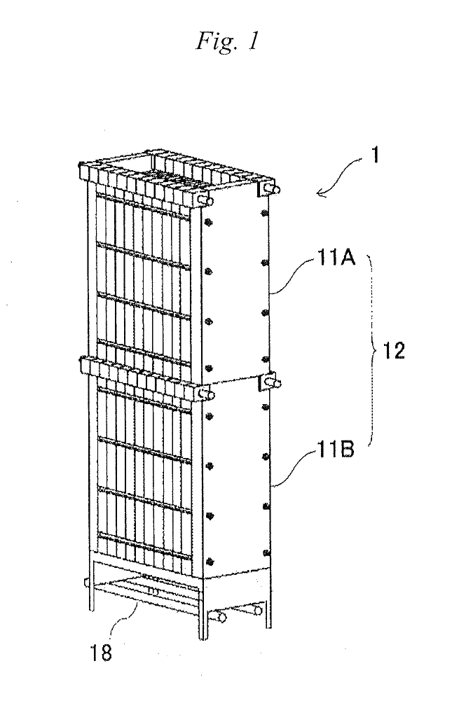

Regarding the multi-stage submerged type membrane separation device according to the invention (hereinafter also referred to as “the present device”), the invention is explained below with reference to an exemplification of the multi-stage submerged type membrane separation device having two membrane units as shown in FIGS. 1 to 3.

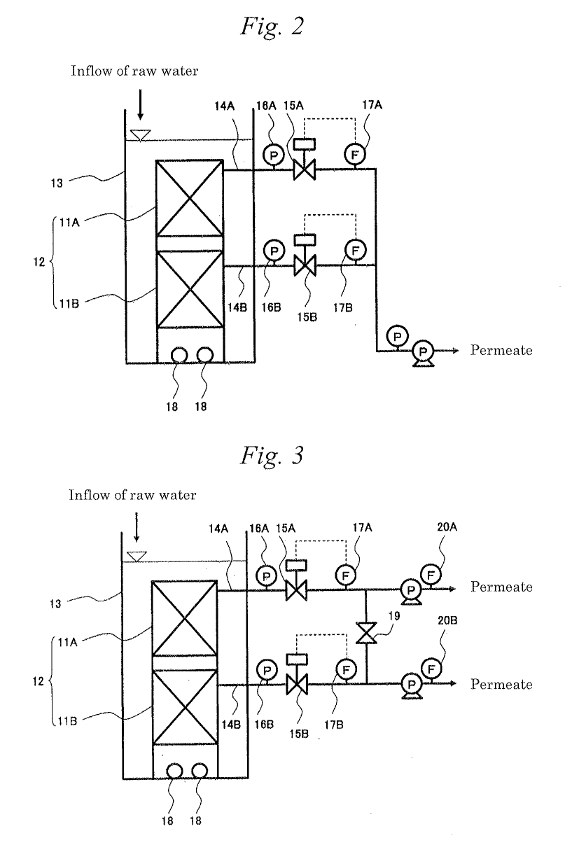

The multi-stage submerged type membrane separation device shown in FIG. 1 has a membrane module 12 in which two membrane units, a membrane unit 11A and a membrane unit 11B, are placed vertically. As shown in FIGS. 2 and 3, the membrane module 12 is submerged in water to be treated which is stored in a water-to-be-treated storage tank 13.

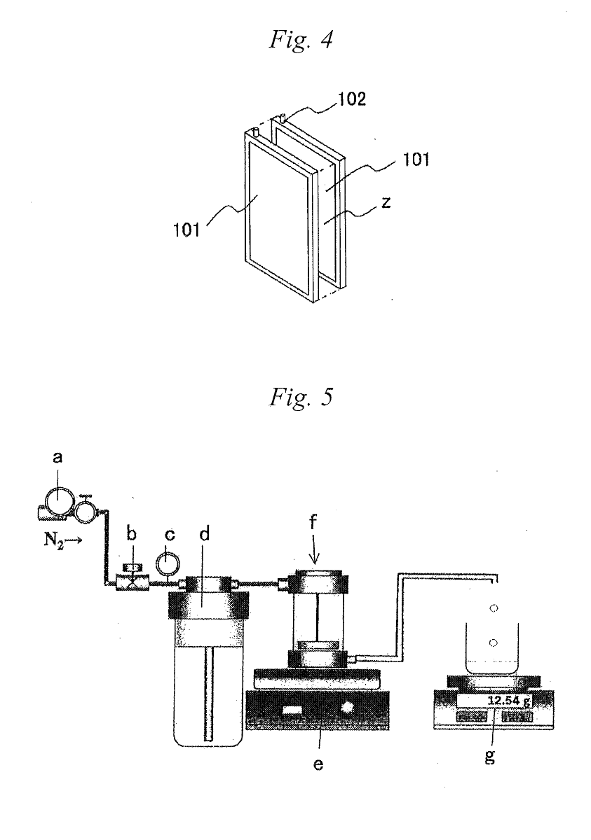

In each membrane unit, as shown in FIG. 4, a plurality of flat sheet membrane elements 101 having a sheet-form separation membrane are disposed with a given spacing so that their membrane faces become parallel. Each flat sheet membrane element is an element having a sheet-form separation membrane, and for example, a flat sheet membrane element 101 having a structure that a sheet-form separation membrane is installed on each of the front and back sides of a frame formed e.g. from resin or metal and a permeate outlet communicating with an internal space enclosed by the separation membranes and the frame is provided at the top of the frame, is used. A set of adjacent flat sheet membranes 101 is shown in FIG. 4 (a schematic perspective view). Between flat sheet membranes 101 adjacent to each other is allowed a given spacing (usually 6 to 10 mm), and through this inter-membrane space z is made to flow an upward-moving current of water to be treated, particularly an upward-moving current of mixture of water to be treated and air bubbles generated from an air diffuser 18 described hereinafter.

The membrane units 11A and 11B are communicated with permeate pipelines 14A and 14B, respectively, into which permeates having passed through separation membranes are discharged. Permeate is sent from the permeate outlet 102 of each of flat sheet membrane elements mounted inside each membrane unit into the permeate pipeline 14. The permeate pipelines 14A and 14B have their respective instruments installed thereon, specifically flow rate control valves 15A and 15B capable of controlling permeate flow rates, pressure gauges 16A and 16B for measurement of pressure on the permeate side and flowmeters 17A and 17B by which permeate flow rates are measured. As shown in FIG. 2, permeates may be gathered by the permeate pipelines 14A and 14B finally communicating with each other and discharged into the outside of the system, or as shown in FIG. 3, permeates may be discharged from the permeate pipelines 14A and 14B, respectively. In the case where the pipelines are finally communicated with each other as shown in FIG. 2, the number of pumps to be installed is reduced, the space for installation of pumps becomes small, and pump maintenance also becomes easy. On the other hand, in the case where permeates are discharged separately as shown in FIG. 3, each of the flow rates of upper-stage permeate and lower-stage permeate can be controlled individually according to the necessity, and it becomes possible to take measures appropriate to situations.

As the driving force for filtration, one example thereof is that the interior of each permeate pipeline is reduced in pressure by operating a pumping device (not depicted), whereby water to be treated in the water-to-be-treated storage tank is filtrated through separation membranes. The filtrate is taken out to the outside of the system by way of the permeate pipeline. Incidentally, in order to reduce the pressure inside each permeate pipeline, difference in water level may be utilized without providing a pumping device.

The air diffuser 18 for generation of air bubbles is installed beneath the membrane module 12 in the water-to-be-treated storage tank. By a jet of air issuing from the air diffuser 18, air bubbles are generated in the interior of the water-to-be-treated storage tank 13. An upward-moving air-liquid mixture current generated by air-lift action of a jet of air in addition to air bubbles flows into the lowermost-stage of membrane unit, and further flows into a membrane unit situated in an upper position while newly accompanying mixed liquid in the tank as appropriate. In this way, the separation membrane surfaces are cleaned, whereby transmembrane plugging can be prevented from occurring and further formation of a cake layer likely to adhere to and deposit on separation membrane surfaces can be inhibited. More than one air diffuser 18 may be installed according to the necessity.

In the device according to an embodiment of the present invention, a membrane unit having the lowest sludge-filtration resistance or the lowest pure-water permeation resistance is placed at the lowermost stage of the membrane module. To be more specific, in the embodiment shown in FIGS. 1 to 3, the membrane unit 11B has the lowest sludge-filtration resistance or the lowest pure-water permeation resistance. This action is taken in view of the fact that, when a membrane separation device is operated practically, in a membrane module having membrane units stacked vertically in stages, a membrane unit installed at the lowermost stage is limited in membrane surface cleaning effect by air diffusion as compared with membrane units installed at the upper stages, whereby the lower-stage membrane units are apt to suffer clogging and become plugged at the earlier times. In such a case, in order to supplement a filtration flow rate lowered by plugging of the membrane module located at the lowermost stage, a burden is placed on the upper-stage membrane units to result in progression of plugging even in the membrane units located at upper stages.

With this being the situation, even though the power for cleaning thereof is weak, a membrane unit located at the lowermost stage can ensure sludge permeability through the minimization of its filtration resistance, whereby it becomes possible to maintain a rise in transmembrane pressure difference due to clogging of the membrane pores at a low speed and to reduce the frequency of taking out membrane units and cleaning them.

The expression of “sludge-filtration resistance of a membrane unit” as used in the present invention refers to the difficulty in making sludge permeate through a separation membrane, or equivalently, the value signifying the degree of membrane clogging (plugging) by filtration, and more specifically, the value obtained by dividing a transmembrane pressure difference (a difference between primary-side pressure and secondary-side pressure) by a permeate flow rate.

However, constituents of sludge are not uniform in their permeability through a separation membrane, and hence transposition may occur in the order of strength of filtration resistance with respect to a plurality of separation membranes and a membrane unit as an aggregate of separation membranes. Accordingly, at the occasion of practically installing a submerged type membrane separation device, it is appropriate that the sludge-filtration resistance measurements in the installation place is made on each separation membrane, and separation membranes to be mounted in a flat sheet membrane element is chosen on the basis of the thus measured resistance values, and membrane units are assembled as appropriate into a membrane module.

By the way, the expression of “sludge-filtration resistance is low” has the same meaning as the expression of “sludge permeability is high”, and the expression of “sludge-filtration resistance is high” has the same meaning as the expression of “sludge permeability is low”.

In the present invention, the sludge-filtration resistance of a membrane unit is measured according to methods mentioned below. The methods fall into two broad categories: (A) methods of the type which directly determine sludge-filtration resistance of a membrane unit in its entirety and (B) methods of the type which indirectly determine sludge-filtration resistance of a membrane unit by measuring sludge-filtration resistance of a representative membrane contained in the membrane unit and dividing the measured resistance by the area of membranes contained in the membrane unit. From the viewpoint of accurately determining sludge-filtration resistance of a membrane unit in its entirety, the methods of the type (A) are preferred, but it does not matter to adopt the methods of the type (B) from the viewpoint of allowing convenient measurement through the use of a small amount of sludge.

The methods of the type (A) are as follows.

In the present invention, sludge-filtration resistance during the early stages of operation is preferred. Accordingly, the sludge-filtration resistance of a membrane unit can be determined as the value obtained by dividing a transmembrane pressure difference soon after the start of using the membrane unit by a permeate flow rate. After the membrane unit has been used, to begin with, clogging of the membrane unit is resolved to the greatest extent practicable, then transmembrane pressure difference and permeate flow rate measurements are carried out, whereby sludge-filtration resistance of the membrane unit can be determined in the same way. As a method for resolving membrane clogging, it is preferable herein to submerge a membrane unit targeted for evaluation into a tank in which an aqueous solution of chemicals is stored in an amount large enough to submerge the membrane unit in the solution (This tank may be a tank different from the water-to-be treated storage tank 13, or it may be the water-to-be-treated storage tank 13 to which an aqueous solution of chemicals is added after removal of sludge accumulated therein). Herein, the submersion time is desirably 2 hours or longer, more desirably 4 hours or longer, and most desirably 10 hours or longer. According to determination of the composition of matter causing membrane clogging, the aqueous solution of chemicals may be prepared as appropriate whenever necessary. When the matter causing membrane clogging is organic matter, an aqueous solution containing 4,000 mg/l or more of hypochlorous acid or an aqueous sodium hydroxide solution having pH of 12 or higher can be used appropriately, and when the matter causing membrane clogging is inorganic matter, an aqueous solution containing 0.1% or higher of oxalic acid or an aqueous solution containing 2% or higher of citric acid etc. can be used appropriately. In addition, there may be cases where firm sludge cake is formed between membrane elements. Accordingly, it is appropriate in such cases that the sludge cake is physically eliminated before the foregoing submersion in a solution of chemicals or a stream of a solution of chemicals is made by aeration from the downward region of membrane units during the submersion in the solution of chemicals.

The foregoing method of the type (B) is as follows.

To begin with, representative membranes are cut out from a membrane unit targeted for evaluation. As to the membranes to be cut out, separation membranes are cut out from positions chosen randomly from a membrane element drawn randomly from a plurality of membrane elements contained in a membrane unit. On this occasion, though it is appropriate that the greatest possible number of representative membranes are cut out and evaluations is performed thereon, at least 3 or more, preferably at least 5 or more, far preferably at least 10 or more, representative membranes are cut out, sludge-filtration membrane resistance measurements are made on the cut-out membranes according to the method described below, the average of these measurement values is calculated, and the average value obtained is defined as the sludge-filtration membrane resistance. And the sludge-filtration resistance of the unit is calculated by dividing the thus obtained sludge-filtration membrane resistance by the area of membranes contained in the unit.

The method for performing evaluation of resistance to membrane filtration of sludge on the representative cut-out membranes is as follows.

To begin with, membrane conditioning is carried out. Specifically, the membranes are cleaned with chemicals when the membranes have already been used, while when the membranes are not used yet, the separation membranes are submerged in ethanol for 15 minutes, further submerged in water for 2 hours or longer, and then rinsed with pure water. The cleaning with chemicals is carried out by submerging the membranes in an aqueous solution of chemicals similarly to the foregoing submersion cleaning of the membrane unit, and the submersion time herein is desirably 2 hours or longer, more desirably 4 hours or longer, and most preferably 10 hours or longer. The aqueous solution of chemicals may be determined as appropriate at any time with reference to the composition of matter causing membrane clogging, and when the matter causing membrane clogging is organic matter, an aqueous solution containing 4,000 mg/l or more of hypochlorous acid or an aqueous sodium hydroxide solution having pH of 12 or higher can be used appropriately, while when the matter causing membrane clogging is inorganic matter, an aqueous solution containing 0.1% or higher of oxalic acid or an aqueous solution containing 2% or higher of citric acid etc. can be used appropriately.

By carrying out the following experiment on basic filtration of sludge through the use of the membranes having undergone the foregoing conditioning, resistance to membrane filtration of sludge is measured. As to the sludge used in measurement, sludge in which the membrane unit has been submerged or is to be submerged is collected and used preferably within one week of going on cold storage. When sludge is difficult to collect, activated sludge from another sewage disposal plant may be used as a substitute for the sludge.

An experimental apparatus for basic filtration of sludge is configured as shown in FIG. 5 to monitor every unit time with an electronic scale the quantity of permeate passing through an agitation-type cell (Amicon 8010 with an effective membrane area of 4.1 cm², produced by Millipore) under conditions of pressurizing the reserve tank with nitrogen gas (Chia-Chi Ho & A. L. Zyndney, Journal of Colloid and Interface Science, 2002, 232, p. 389). The electronic scale is connected to a computer, and thereafter membrane permeability resistance is calculated from the change in weight with passage of time. Membrane surface flux is given to the membrane surface by rotation of a magnetic stirrer attached to an agitation-type cell, in which the agitating speed in the agitation-type cell is adjusted consistently to 600 rpm, the evaluative temperature is set at 25° C. and the evaluative pressure is set at 20 kPa. Evaluations are performed in the order described below. By the way, the membrane resistance may be calculated through conversion of water temperature into the viscosity of evaluative liquid.

Herein, the membrane resistance R is determined by the following expression.

R=(P×t×S)/L
R: Membrane resistance (m²×Pa×s/m³)
P: Evaluative pressure (Pa)
T: Permeation time (s)
L: Permeate quantity (m³)
S: Membrane area (m²)

With continuation of filtration of sludge, the sludge is beginning to adhere to membrane surface, and the membrane resistance R varies with time and is on an upward trend. However, there is a period during which the value of membrane resistance R remains invariant owing to balance between adhesion and peeling caused by agitation. This constant value of membrane resistance is defined as sludge-filtration membrane resistance.

The resistance to pure-water permeation through a unit is evaluated by changing the fluid to be filtrated from sludge to pure water or reverse osmosis membrane permeate in the foregoing method for measuring the sludge-filtration resistance.

In the device according to embodiments of the present invention, it is appropriate that the sludge-filtration resistance or pure-water permeation resistance of the lowermost-stage membrane unit is at least 10%, preferably at least 15%, particularly preferably at least 30%, most preferably at least 50%, lower than the sludge-filtration resistance or pure-water permeation resistance of any one (preferably all) of other membrane units, namely those placed in upper positions as compared to the lowermost-stage membrane unit. By adjusting the sludge-filtration resistance or pure-water permeation resistance of the lowermost-stage membrane unit to fall into such a range as mentioned above, a good balance between the lowermost-stage membrane unit and membrane units placed in upper positions can be achieved during the performance of practical operations.

By controlling in the foregoing manner the resistance to filtration through each of a plurality of membrane units and the order in which the plurality of membrane units are installed in a membrane module, it becomes possible to achieve extension of an operation period of time elapsing before each membrane unit requires cleaning and to synchronize cleaning periods of the plurality of membrane units contained in the membrane module, which situation is promising for high-efficiency maintenance of the device.

Examples of a method usable for realizing the foregoing order in which membrane units are installed include a method of making the membrane units equal in the number of membrane elements constituting them each and mounting, in a membrane unit to be placed at the lowermost stage, membranes lower in sludge-filtration membrane resistance than membranes mounted in the other membrane units, and a method of using, in every membrane unit, membranes with almost the same level of sludge-filtration membrane resistance and increasing the number of membrane elements in the lowermost-stage membrane unit.

Additionally, separation membranes used therein may be commonly-used porous membranes, and examples thereof include separation membranes made from a (polyvinylidene fluoride)-based resin, a polyacrylonitrile-based resin, a acrylonitrile-styrene copolymer, a polysulfone-based resin, a (polyether sulfone)-based resin or a polyolefin-based resin. Of these separation membranes, the separation membrane made from a (polyvinylidene floride)-based resin is preferably used. The thickness of a separation membrane may be in a range of 0.01 mm to 1 mm, and preferably from 0.1 mm to 0.7 mm.

A flat sheet membrane element includes separation membranes and an intake section, and further may include a support plate and a channel member according to the necessity. The separation membranes have no particular restrictions so long as they are in sheet form and have such a structure as to allow water to pass through them and enter into the flat sheet membrane element. In addition, a support plate may be provided between two separation membranes, whereby the separation membranes may be kept in a flat form. Further, a channel member may be provided between two separation membranes or between a separation membrane and a support plate, whereby a structure may be formed which allows an easy flow of treated water having passed through separation membranes into the intake section while keeping the separation membranes in a flat form. The dimensions of a flat sheet membrane element have no particular limitations, but from the viewpoints of easiness of handing and maximization of aeration energy, it is appropriate for the membrane element to have dimensions of 300×300 mm to 2,000×2,000 mm, preferably 500×1,000 mm to 500×1,500 mm.

It is essential only that the membrane module should include at least two membrane units, and further an aerator may be provided for each membrane unit. However, it is preferred that one aerator is provided for one membrane module. A plurality of membrane units are stacked vertically, but it is appropriate that two or three membrane units are included for each membrane module.

On the other hand, permeate pipelines for sending permeates having passed through separation membranes in membrane units have no particular restrictions so long as they are stable toward water to be treated, treated water and a cleaning solution containing chemicals, and specifically, pipelines made of plastic or metal may be mentioned. Particularly, pipelines made of metal are preferred.

As to the configuration of permeate pipelines, it is appropriate in terms of installation and maintenance that one permeate pipeline is communicated with one membrane unit.

Further, it is preferred that the permeate pipeline communicating with the membrane unit placed at the lowermost stage in the membrane module is connected to at least one permeate pipeline placed upward. This is because, though the number of pumps installed may be the same as the number of permeate pipelines when the pumps are installed for flow rate control, connections between permeate pipelines make it possible to reduce the number of required pumps by the number of connections.

Herein, it is worthy of note that, because filtration resistance varies from one membrane unit to another, even when permeates in a plurality of membrane units and permeate pipelines communicating therewith, respectively, are sucked up with one pump, the membrane units are different from each other in actual suction pressure and flux according to filtration resistance of each individual membrane unit, and flow rate control appropriate to each individual membrane unit becomes possible.

Further, the device of the present invention preferably has a flow rate control means in order to control the flow rate of permeate sent through each permeate pipeline. As the flow rate control means, a pumping machine, a flow rate control valve and the like can be given as examples. From the viewpoint of reduction in energy consumption in particular, a flow rate control valve is preferred.

It is appropriate that a flow rate control means is installed in the permeate pipeline communicating with the membrane unit placed at the lowermost-stage in the membrane module, and it is also appropriate that another flow rate control means is installed in a permeate pipeline communicating with another membrane unit, namely at least one membrane unit placed upward.

In addition, it is appropriate that the permeate pipeline communicating with the membrane unit placed at the lowermost-stage in the membrane module and the permeate pipeline communicating with a membrane unit placed upward each has a flow rate control means which is capable of controlling independently of each other. This is because, since the membrane unit placed at the lowermost stage is most likely to clog, the balance between the permeate flow rate in the membrane unit placed at the lowermost-stage and the permeate flow rate(s) in the membrane unit(s) placed upward is adjusted, whereby increase in longevity of membrane units can be achieved.

The device of the present invention may have a pressure measuring means for determining the permeate-sucking pressure at the time of filtration in substitution for or in combination with the flow rate control means as described above. It is essential only that the operational pressure difference between the permeate-sucking pressure during the filtration and the pressure during the filtration stop can be determined.

Cases where the operational pressure difference in separation membranes of the membrane unit placed at the lowermost stage in the membrane module is greater than a predetermined value mean a state that the membrane unit has high resistance to sludge and low sludge permeability, or equivalently, the membrane is beginning to plug up owing to the clogging.

As to the foregoing predetermined value, depending on the properties of water to be treated, the operational pressure difference is desirably from 10 kPa to 40 kPa, more desirably 20 kPa or below.

In cases where the operational pressure difference increases beyond the predetermined value, it is appropriate to adopt a means of cleaning the membrane unit with chemicals, or increasing the quantity of air diffused or the duration of air diffusion from an air diffuser, or reducing the flow rate of permeate in the membrane unit placed at the lowermost stage. By adopting such a means, the operational pressure difference is lowered to the order of 5 to 10 kPa, and filtration operation can be performed favorably.

The term “cleaning with chemicals” as used herein means that a plugged separation membrane is subjected to backwashing from the secondary side of the separation membrane through the use of acid and alkaline chemicals, and examples of chemicals used include sodium hypochlorite, citric acid and oxalic acid. Of these chemicals, sodium hypochlorite and citric acid are preferably used.

In the case of increasing the quantity of air diffused from an air diffuser, it is appropriate that an increment in the quantity of air is about 10 to 50% of the usual quantity of air.

Regarding a time period for air diffusion from an air diffuser, the air diffusion can be carried out intermittently in some cases, but the air diffusion is preferably performed continuously.

Incidentally, the cleaning with chemicals and the increment in quantity of air diffused or the duration of air diffusion vary greatly according to the type, temperature, viscosity and other constitutions of water to be treated, and therefore it is required to select the best conditions and carry out membrane separation under the selected conditions as occasion arises.

In order to deal with cases in which not only the operational pressure difference in the lowermost-stage membrane unit but also the flow rate value or pressure difference of permeate obtained by permeation through separation membranes in the membrane unit placed at the lowermost stage becomes smaller than a predetermined value, or cases in which the difference between the flow rate value or pressure value of permeate obtained by permeation through separation membranes in the membrane unit placed at the lowermost stage and the flow rate value or pressure value of permeate obtained by permeation through separation membranes in any of the other membrane units becomes greater than a predetermined value, it is also possible to adopt the same means as mentioned above, namely a means of cleaning the lowermost-stage membrane unit with chemicals, or increasing the quantity of air diffused or the duration of air diffusion from the air diffuser, or reducing the flow rate of permeate in the lowermost-stage membrane unit.

The expression of “a difference in flow rate of permeate or pressure of permeate is greater than a predetermined value” means a state that the membrane unit is becoming high in resistance to sludge and low in sludge permeability, or equivalently, the membrane unit is beginning to plug up owing to clogging.

On the other hand, the term “predetermined value” refers to the value which can be determined on a measurement value allowing assessment of a filtration flow rate or filtration pressure under operation, such as a filtration flux, a filtration flow rate, a filtration pressure or a filtration pressure difference, in consideration of filtration operation conditions and conditions of sludge and water to be treated.

Further, it is appropriate that membrane separation is conducted under conditions that the flow rate is controlled using a flow rate control means as mentioned above so that the flow rate of permeate obtained by permeation through separation membranes in the membrane unit placed at the lowermost stage of a membrane module becomes smaller than the flow rate of permeate obtained by permeation through separation membranes in at least any one of other separation units, namely, one or more membrane units placed upward. By intentionally reducing the quantity of water passing through the membrane unit placed at the lowermost stage of a membrane module, the time elapsing before the lowermost-stage membrane unit becomes plugged can be extended.

In other words, by adjusting the flow rate in the lowermost-stage membrane unit to be low and the flow rate(s) in the upper-stage membrane unit(s) to be rather high, the time elapsing before the membrane units require cleaning can be made longer, and besides, the timings in cleaning the plurality of membrane units can be adjusted to be synchronized, whereby all the membrane units can be taken out at a time for cleaning and can be subjected to cleaning.

In addition, it is appropriate that a difference between the flow rate of permeate passing through the lowermost-stage membrane unit and the flow rate of permeate passing through at least one or more membrane units is 10% or smaller. This is because similar permeate pipelines can be used for the lowermost-stage membrane unit and the membrane unit(s) placed upward, whereby not only operational malfunctions due to mistakes in installation can be reduced but also piping resistance can be reduced.

Making an additional remark, a further increase in longevity of membrane units can be expected by adjusting the flow rate of a membrane unit placed at a lower stage to be the lower and that of a membrane unit placed at a higher stage to be the higher.

On the other hand, substitution of a pressure control means for the flow rate control means can also produce an effect similar to the above. In this case, it is essential only that the pressure difference between water to be treated and permeate is adjusted to rise somewhat slowly in the membrane unit placed at the lowermost stage, while it is adjusted to rise somewhat rapidly in membrane unit(s) placed upward. And a further increase in longevity of membrane units can be expected by adjusting membrane units placed at lower stages to be the slower in pressure difference rise and membrane units placed at higher stages to be the more rapid in pressure difference rise.

Further, by connecting the permeate pipeline communicating with the membrane unit placed at the lowermost stage to the permeate pipeline communicating with another membrane unit placed upward and carrying out membrane filtration and so on by the use of driving force generated from one and the same suction pump, transmembrane pressure differences of these membrane units can be always kept almost the same. In this case, it also becomes possible to control a transmembrane pressure difference of each individual membrane unit by giving resistance to a flow of permeate through the use of a flow rate control valve or the like provided in each permeate pipeline. And it is appropriate that a difference between the transmembrane pressure differences is adjusted to fall within ±10%. Thereby, not only pump power can be utilized without being wasted, but also a membrane unit in which membrane clogging is in progress comes to be spontaneously reduced in membrane filtration flow rate by the clogging quantity, and well balanced utilization comes to be attained between membrane units.

Detailed explanations are as follows. For example, in the case where the transmembrane pressure difference is always kept almost the same, soon after the start of membrane filtration or soon after the cleaning of membranes with chemicals, since the lowermost-stage membrane unit is the lowest in sludge-filtration resistance among the membrane units in a membrane module, the filtration flow rate in the lowermost-stage membrane unit becomes the greatest. When filtration is carried out in such a membrane module, the filtration flow rate in the lowermost-stage membrane unit is gradually lowered because membrane cleaning effect is weak at the lowermost stage. As time further goes by, it is thought that the filtration flow rate in the lowermost-stage membrane unit becomes lower than the filtration flow rate(s) in membrane unit(s) placed upward. However, as mentioned above, the lowermost-stage membrane unit has the lowest initial sludge-filtration resistance among the membrane units in a membrane module, and the filtration flow rate lowering speed thereof is also low. As a result, the transmembrane pressure difference rising speed in the overall membrane module can be held down, whereby filtration operation can be continued stably even though the chemical cleaning interval is long.

Although the submerged-type membrane separation device and membrane separation method according to the present invention have been illustrated above with an eye on sludge-containing water to be treated, they can treat not only activated sludge but also river water, lake water, ground water, seawater, sewage, wastewater, effluent from food processing or so on as water to be treated and perform elimination of suspension in the water to be treated, whereby it become possible to utilize them for various purposes, including water purification treatment, wastewater treatment, drinking water production, industrial water production and so on.

### EXAMPLES

The invention will now be illustrated below with reference to examples, but these examples should not be construed as limiting the scope of the invention in any way.

### <Preparation of Separation Membrane>

Polyvinylidene fluoride (PVDF) was used as a resin component for a membrane-forming stock solution. In addition, polyoxyethylene sorbitan monostearate, N,N-dimethylformamide (DMF) and H₂O were used as a pore opening agent, a solvent and a nonsolvent, respectively. These ingredients were thoroughly mixed together with stirring under a temperature of 95° C., and membrane-forming stock solutions having the compositions shown in Table 1, respectively, were prepared.

A base material used for separation membranes was rectangle-shaped nonwoven fabric which was made from polyester fibers and had a density of 0.42 g/cm³, a width of 50 cm and a length of 150 cm. Then, each of the membrane-forming stock solutions was cooled to 30° C., and applied to the base material. Immediately after the application, the resulting material was immersed in 20° C. pure water for 5 minutes, and further immersed in 90° C. hot water for 2 minutes, whereby N,N-dimethylformamide as solvent and polyoxyethylene sorbitan monostearate as the pore opening agent were flushed out. In this manner, composite separation membranes 1 to 8 were prepared.

### <Sludge-Filtration Resistance and Pure-Water Permeation Resistance Measurements>

By the use of the above-mentioned method for carrying out experimentation of sludge-filtration resistance, sludge-filtration resistance measurements were performed on each of the separation membranes 1 to 8 prepared according to their respective compositions and the method mentioned above.

As sludge to be used in sludge-filtration resistance measurements on the separation membranes, a sludge solution was prepared by acclimatizing sludge collected from a sewage disposal plant for about one year on a dextrin culture medium (constituted of 12 g/L of dextrin, 24 g/L of polypeptone, 7.2 g/L of ammonium sulfate, 2.4 g/L of monopotassium phosphate, 0.9 g/L of sodium chloride, 0.3 g/L of magnesium sulfate heptahydrate and 0.4 g/L of calcium chloride dihydrate) on condition that the BOD volumetric load was 1 g-BOD/L/day and the water residence time was one day, and further the sludge solution (MLSS: 15.17 g/L) was diluted with reverse osmosis membrane filtrate so that the MLSS was reduced to 1 g/L. By the use of the thus diluted sludge solution, paper filtration testing was carried out. Therein, it was found that, when 50 mL of the diluted sludge solution was filtrated through a paper filter having a pore size of 1 μm (No. 5C) at a temperature of 20° C. over 5 minutes, the quantity of permeate obtained was 19.8 mL. The viscosity of the diluted sludge solution was measured with a viscometer (VT-3E, Rotor No. 4, a product of RION Co., Ltd.) and found to be 1.1 mPa·s (20° C.).

Each separation membrane was immersed in ethanol first, then in water in place of the ethanol, and further rinsed with pure water for about 5 minutes. After removal of a reserve tank, an agitation-type evaluation cell was filled with the diluted sludge solution (15 g) in a state that the membrane after evaluation was set in the cell, and filtration of a predetermined amount (7.5 g) of the diluted sludge solution was carried out. By the time when the filtration of the predetermined amount of diluted sludge solution was finished, membrane resistance was worked out for every predetermined time, and the membrane resistance came to be held almost constant for the last 20 seconds during the filtration of the sludge. Thus this constant membrane resistance was defined as sludge-filtration membrane resistance R. Likewise, pure-water permeation resistance R was determined. Results obtained by these experiments are shown in Table 2. As the separation membranes 1 to 8, membranes differing from one another in sludge-filtration membrane resistance and pure-water permeation resistance were obtained.

### <Preparation of Flat Sheet Membrane Element>

Flat sheet membrane elements were made using the separation membranes 1 to 8 differing in sludge-filtration resistance, respectively. Each of the flat sheet membrane elements was made in principle on the basis of Element TSP-50150, a product of Toray Industries, Inc. Each flat sheet membrane element had a structure that an intake nozzle was installed at the top of the element and separation membranes were made to adhere to both sides of a supporting plate with dimensions of 1,600 mm×500 mm, and the area of separation membranes was 1.4 m². Each flat sheet membrane element was made by cutting out two sheets of each individual separation membrane to suite the size of the element and putting the sheets on both sides of the supporting plate of the element, respectively.

### <Preparation of Membrane Unit>

TMR140, a product of Toray Industries, Inc., was used as a membrane unit. To begin with, the membrane unit was constructed from flat sheet membrane elements using separation membranes of the same kind chosen from the foregoing separation membranes, and then a membrane module was prepared by stacking up an air diffusing block, a lower-stage membrane unit, an intermediate block and an upper-stage membrane unit in this order. As the lower-stage membrane unit and the upper-stage membrane unit, membrane units constructed by incorporating therein 20 sheets of the above-mentioned flat sheet membrane elements per membrane unit were used.

### <Configuration of Membrane Module>

Membrane separation testing was carried out by using a submerged-type membrane separation device including a membrane module equipped with two membrane units, one of which was placed at the lower stage and relatively low in sludge-filtration resistance and pure-water permeation resistance and the other of which was placed at the upper stage and relatively high in sludge-filtration resistance and pure-water permeation resistance. A difference in filtration resistance between the lower-stage unit and the upper-stage unit was calculated by the following expression.

Sludge-filtration resistance difference=(Sludge-filtration resistance of membranes used in the upper-stage membrane unit/membrane area of the membrane unit−sludge-filtration resistance of membranes used in the lower-stage membrane unit/membrane area of the membrane unit)×100÷(sludge-filtration resistance of membranes used in the lower-stage membrane unit/membrane area of the membrane unit).

Pure-water permeation resistance difference=(Pure-water permeation resistance of membranes used in the upper-stage membrane unit/membrane area of the membrane unit−pure-water permeation resistance of membranes used in the lower-stage membrane unit/membrane area of the membrane unit)×100÷(pure-water permeation resistance of membranes used in the lower-stage membrane unit/membrane area of the membrane unit)

Membrane unit compositions of the membrane modules used, namely the membrane modules 1 to 8, and filtration resistance differences of these membrane modules are shown in Table 3.

### <Filtration Operation Test on Membrane Module>

Test conditions were as follows.

Domestic wastewater was treated under the conditions shown all together in Table 4. Domestic wastewater was introduced into a denitrification tank by means of a raw-water feed pump and subjected to treatment, and the resulting liquid was introduced into a membrane bioreactor tank. In the membrane bioreactor tank, an aerobic condition was maintained by aeration supplied from a membrane module, and filtration of treated water was performed. Incidentally, sludge was drawn out periodically by means of a sludge drawing pump in order to retain MLSS concentration. The filtration operation of each membrane module was carried out in a constant flow-rate operation mode.

### Example 1

In Example 1, experiments were conducted using the membrane module 1 in a membrane separation system configured as shown in FIG. 3. The experiments were carried out under conditions that the valve 19 connecting together permeates from the upper and lower stages was closed, and the filtration flow rates in the upper and lower stages each were controlled independently. Each of the lower and upper membrane units was provided with a pressure gauge, a flowmeter and a filtration pump, and suction filtration was carried out in a state that the flowmeter and the filtration pump were ganged together. In this way, constant flow-rate filtration operation was performed. The filtration flux was 1.0 m/d, and a filtration cycle of 9-minute filtration and 1-minute standstill was repeated. The filtration pressure difference was worked out by reading filtration operation pressure after a lapse of 8 minutes from the start of filtration operation and pressure after a lapse of 50 seconds from a stoppage of filtration, and subtracting the readout of the filtration stoppage pressure from the readout of the filtration operation pressure.

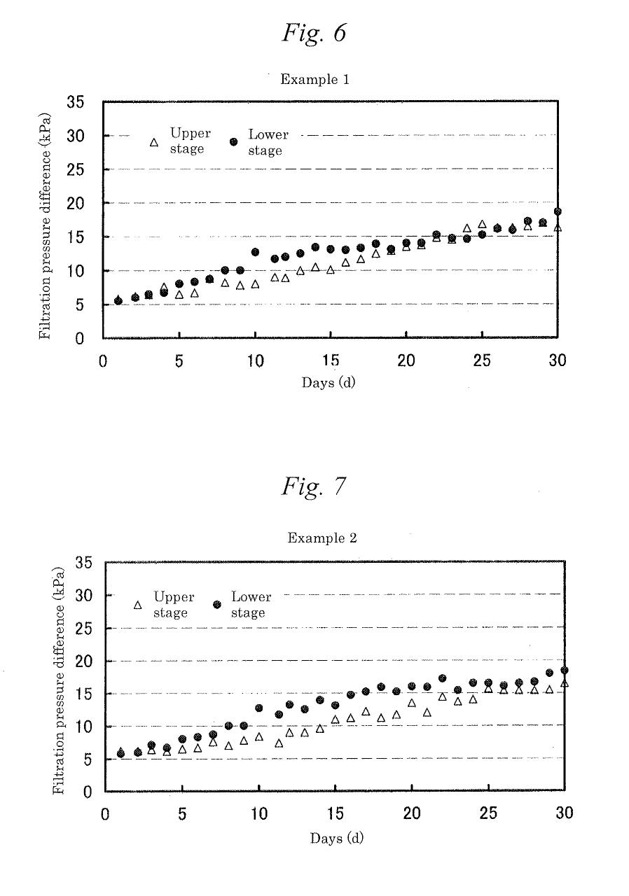

The filtration operation was started in a situation that the filtration pressure difference was on the order of 5 kPa to 6 kPa and made to continue for one month under the filtration operation conditions specified above. Developments since the filtration operation was started are shown in FIG. 6. In addition, the rising speed of a pressure difference per day of the upper-stage membrane unit and that of the lower-stage membrane unit was worked out by dividing the filtration pressure difference after one month by 30 (day). Results obtained are shown in Table 5.

By the way, the filtration pressure difference allowing consistent filtration operation was taken as 25 kPa. Thus, the reference value for controlling the operation pressure difference after one-month operation to 20 kPa or below was evaluated to be, in terms of a pressure difference rising speed per day, (25−5) kPa÷30 days≈0.67 kPa/d or below.

As shown in Table 5 and FIG. 6, the filtration pressure differences obtained as experimental results in the upper-stage and lower-stage membrane units were small as compared to the reference value of 0.67 kPa/d, and long-term stable operation is therefore thought to be possible.

### Example 2

Experiments were carried out in the same manner as in Example 1, except that the membrane module 2 was used. As shown in Table 5 and FIG. 7, the filtration pressure differences obtained as experimental results in the upper-stage and lower-stage membrane units were small as compared to the reference value of 0.67 kPa/d, and long-term stable operation is therefore thought to be possible.

### Example 3

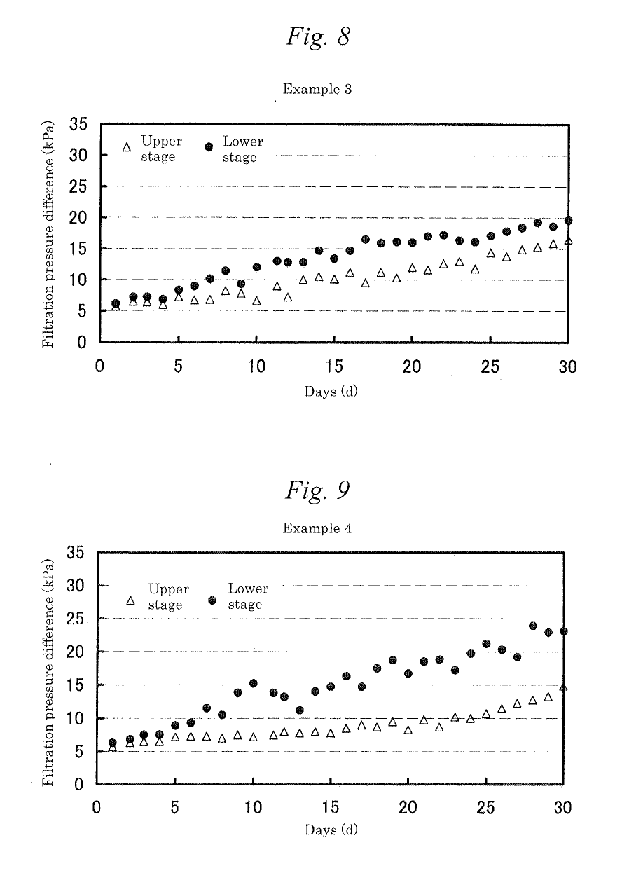

Experiments were carried out in the same manner as in Example 1, except that the membrane module 3 was used. As shown in Table 5 and FIG. 8, the filtration pressure differences obtained as experimental results in the upper-stage and lower-stage membrane units were small as compared to the reference value of 0.67 kPa/d, and long-term stable operation is therefore thought to be possible.

### Example 4

Experiments were carried out in the same manner as in Example 1, except that the membrane module 5 was used. As shown in Table 5 and FIG. 9, the filtration pressure differences obtained as experimental results in the upper-stage and lower-stage membrane units were small as compared to the reference value of 0.67 kPa/d, and long-term stable operation is therefore thought to be possible.

### Example 5

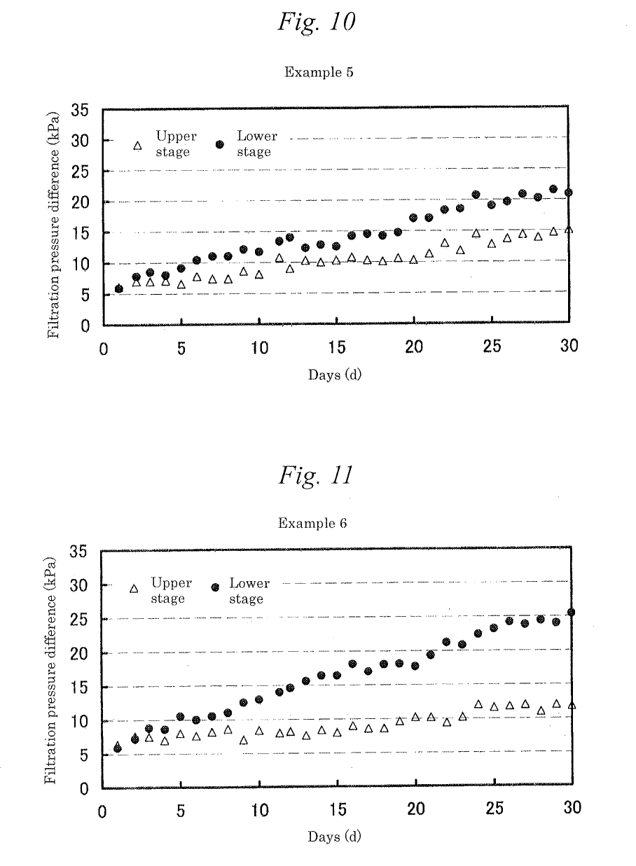

Experiments were carried out in the same manner as in Example 1, except that the membrane module 6 was used. As shown in Table 5 and FIG. 10, the filtration pressure differences obtained as experimental results in the upper-stage and lower-stage membrane units were small as compared to the reference value of 0.67 kPa/d, and long-term stable operation is therefore thought to be possible.

### Example 6

Experiments were carried out in the same manner as in Example 1, except that the membrane module 7 was used. As shown in Table 5 and FIG. 11, the filtration pressure differences obtained as experimental results in the upper-stage and lower-stage membrane units were small as compared to the reference value of 0.67 kPa/d, and long-term stable operation is therefore thought to be possible.

### Example 7

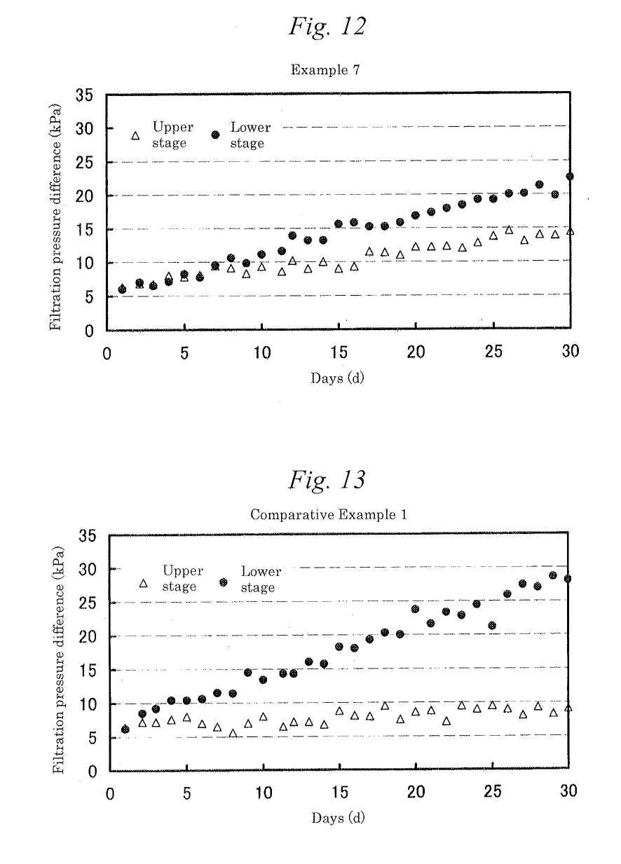

Experiments were carried out in the same manner as in Example 1, except that the membrane module 8 was used. As shown in Table 5 and FIG. 12, the filtration pressure differences obtained as experimental results in the upper-stage and lower-stage membrane units were small as compared to the reference value of 0.67 kPa/d, and long-term stable operation is therefore thought to be possible.

### Comparative Example 1

Experiments were carried out in the same manner as in Example 1, except that the membrane module 4 was used. As shown in Table 5 and FIG. 13, the filtration pressure differences obtained as experimental results in the upper-stage and lower-stage membrane units were large as compared to the reference value of 0.67 kPa/d, and long-term stable operation was impossible.

### Example 8

In Example 8, experiments were conducted using the membrane module 1 in a membrane separation device configured as shown in FIG. 3. The experiments were carried out under conditions that the valve 19 connecting together permeates from the upper and lower stages was opened, and the flow rates in the membrane module were adjusted to 1.17 m³/h by using the flowmeters 20A and 20B independently. Each of the lower and upper membrane units was provided with a pressure gauge, a flowmeter and a filtration pump, and suction filtration was carried out in a state that the flowmeter and the filtration pump were ganged together. In this way, constant flow-rate filtration operation was performed. The filtration flux was 1.0 m/d, and a filtration cycle of 9-minute filtration and 1-minute standstill was repeated. The filtration pressure difference was worked out by reading filtration operation pressure after a lapse of 8 minutes from the start of filtration operation and pressure after a lapse of 50 seconds from a stoppage of filtration, and subtracting the readout of the filtration stoppage pressure from the readout of the filtration operation pressure. Filtration flow rate measurements were made on membrane units by means of flowmeters 17A and 17B, respectively.

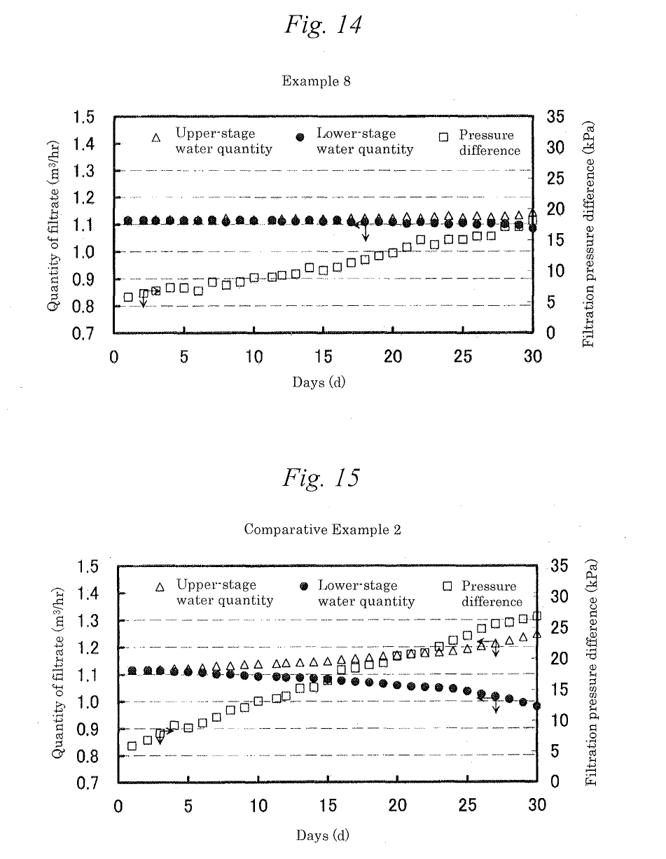

As shown in Table 6 and FIG. 14, the filtration pressure differences obtained as experimental results in the upper-stage and lower-stage membrane units were small as compared to the reference value of 0.67 kPa/d, and long-term stable operation is therefore thought to be possible.

### Comparative Example 2

Experiments were carried out in the same manner as in Example 8, except that the membrane module 4 was used. As shown in Table 6 and FIG. 15, the filtration pressure differences obtained as experimental results in the upper-stage and lower-stage membrane units were large as compared to the reference value of 0.67 kPa/d, and long-term stable operation was impossible.

TABLE 1

| | | | N,N- | |
|---|---|---|---|---|
| | | Polyoxyethylene | dimethyl- | |
| | Polyvinylidene | sorbitan | formamide | |
| | fluoride | monostearate | (DMF) | H₂O |
| | (PVDF, wt %) | (wt %) | (wt %) | (wt %) |
| Membrane 1 | 17.0 | 8.0 | 72.0 | 3.0 |
| Membrane 2 | 16.9 | 8.1 | 72.0 | 3.0 |
| Membrane 3 | 16.8 | 8.2 | 72.0 | 3.0 |
| Membrane 4 | 16.7 | 8.3 | 72.0 | 3.0 |
| Membrane 5 | 16.6 | 8.4 | 72.0 | 3.0 |
| Membrane 6 | 16.5 | 8.5 | 72.0 | 3.0 |
| Membrane 7 | 16.4 | 8.6 | 72.0 | 3.0 |
| Membrane 8 | 16.3 | 8.7 | 72.0 | 3.0 |

TABLE 2

| | Sludge-Filtration | Pure-Water Permeation |
|---|---|---|
| | Resistance R | Resistance R |
| | (10⁷m² · Pa · s/m³) | (10⁶m² · Pa · s/m³) |
| Membrane 1 | 48.2 | 38.4 |
| Membrane 2 | 45.9 | 35.9 |
| Membrane 3 | 44.3 | 35.5 |
| Membrane 4 | 41.7 | 32.1 |
| Membrane 5 | 38.6 | 30.2 |
| Membrane 6 | 37.7 | 30.0 |
| Membrane 7 | 36.2 | 29.1 |
| Membrane 8 | 33.0 | 26.0 |

TABLE 3

| | Membranes | | Sludge- | Pure-Water |
|---|---|---|---|---|
| | Used in Upper- | Membranes | Filtration | Permeation |
| | Stage | Used in Lower- | Resistance | Resistance |
| | Membrane | Stage | Difference | Difference |
| | Unit | Membrane Unit | (%) | (%) |
| Membrane | Membrane 1 | Membrane 4 | 15.6 | 19.7 |
| Module 1 | | | | |
| Membrane | Membrane 1 | Membrane 8 | 46.1 | 47.8 |
| Module 2 | | | | |
| Membrane | Membrane 5 | Membrane 8 | 17.0 | 16.2 |
| Module 3 | | | | |
| Membrane | Membrane 1 | Membrane 1 | 0.0 | 0.0 |
| Module 4 | | | | |
| Membrane | Membrane 1 | Membrane 2 | 5.0 | 7.1 |
| Module 5 | | | | |
| Membrane | Membrane 1 | Membrane 3 | 8.8 | 8.4 |
| Module 6 | | | | |
| Membrane | Membrane 5 | Membrane 6 | 2.4 | 0.6 |
| Module 7 | | | | |
| Membrane | Membrane 5 | Membrane 7 | 6.6 | 3.8 |
| Module 8 | | | | |

TABLE 4

| | |
|---|---|
| Type of raw water | Domestic wastewater |
| Water quality of raw water | Biological oxygen demand: 200 mg/L |
| (average value) | Total nitrogen: 45 mg/L |
| | Total phosphorus: 8 mg/L |
| Amount of treated water | 56 m³/d |
| Capacity of biological | Denitrification tank: 6.8 m³ |
| treatment tank | Membrane bioreactor tank: 6.8 m³ |
| | Total: 13.6 m³ |
| Hydraulic residence time | Denitrification tank: 3 hours |
| | Membrane bioreactor tank: 3 hours |
| | Total: 6 hours |
| Activated sludge | MLSS in membrane bioreactor tank: 8,000 to 15,000 mg/L |
| condition | DO in membrane bioreactor tank: 0.5 to 2.0 mg/L |
| Amount of circulated | 168 m³/d |
| sludge | (three times larger than the amount of water to be treated) |
| Temperature of water to | 20° C. to 25° C. |
| be treated | |
| Air diffuser | Micro-bubbles diffuser tube, made by MISUZU Industry |
| | Co., Ltd. |
| | Cylindrical air diffuser tube made of rubber: 6 pieces |
| Amount of diffused air | 0.8 m³/min |
| | 20 L/min/EL × 40 EL |

TABLE 5

| | Upper-Stage Pressure | Lower-Stage Pressure |
|---|---|---|
| | Difference Rising Speed | Difference Rising Speed |
| | (kPa/d) | (kPa/d) |
| Example 1 | 0.42 | 0.39 |
| Example 2 | 0.39 | 0.42 |
| Example 3 | 0.36 | 0.45 |
| Example 4 | 0.24 | 0.56 |
| Example 5 | 0.30 | 0.50 |
| Example 6 | 0.18 | 0.65 |
| Example 7 | 0.27 | 0.55 |
| Comparative | 0.09 | 0.73 |
| Example 1 | | |

TABLE 6

| | | Upper-Stage | | |
|---|---|---|---|---|
| | | Membrane Unit | Lower-Stage | |
| | Pressure | Filtration Flow | Membrane Unit | |
| | Difference | Rate | Filtration Flow | Filtration |
| | Rising | (m³/hr, after | Rate | Flow-Rate |
| | Speed | 30-day | (m³/hr, after 30- | Difference |
| | (kPa/d) | filtration) | day filtration) | (%) |
| Example 8 | 0.41 | 1.15 | 1.09 | 5 |
| Comparative | 0.72 | 1.25 | 0.98 | 27 |
| Example 2 | | | | |

While the invention has been described above in detail and with reference to specific embodiments thereof, it will be apparent to one skilled in the art that various changes and modifications can be made thereto without departing from the spirit and scope of the invention. This application is based on Japanese Patent Application No. 2012-283468 filed on Dec. 26, 2012, the contents of which are incorporated herein by reference.

The multi-stage submerged type membrane separation device according to the present invention allows extension of a device operation period of time lapsing before there occurs a necessity to clean membranes, and further makes it possible to adjust the timing of membrane cleaning so that a plurality of membrane units become identical in the cleaning timing. Thus it can be said that maintenance of the device of the present invention is easy, and the device has an extended life.

With regard to the device according to the present invention, it is hoped that not only sludge but also river water, lake water, groundwater, seawater, sewage, wastewater, food processing effluent and the like are applicable as water to be treated and membrane separation thereof can be performed.

### DESCRIPTION OF REFERENCE NUMERALS AND SIGNS

1: Multi-stage submerged type membrane separation device
11A and 11B: Membrane unit
12: Membrane module
13: Water-to-be-treated storage tank
14A and 14B: Permeate pipeline
15A and 15B: Flow rate control valve
16A and 16B: Pressure gauge
17A and 17B: Flowmeter
18: Air diffuser
19: Valve
20A and 20B: Flowmeter
101: Flat sheet membrane element
102: Permeate outlet
a: Pressure controller
b: Valve
c: Pressure gauge
d: Reserve tank for feed water
e: Magnetic stirrer
f: Membrane filtration unit
g: Electronic scale

1. A multi-stage submerged type membrane separation device comprising:
a membrane module having a plurality of membrane units stacked vertically in stages, in each of which a plurality of flat sheet membrane elements each having a sheet-shaped separation membrane are arranged;
a water-to-be-treated storage tank in which water to be treated is stored and the membrane module is placed in a state of being submerged in the water to be treated; and
an air diffuser installed beneath the membrane module,
wherein the membrane unit placed at the lowermost stage is lower in sludge-filtration resistance or pure-water permeation resistance than any of the membrane units placed at stages higher than the membrane unit placed at the lowermost stage.

2. The multi-stage submerged type membrane separation device according to claim 1, wherein the membrane unit placed at the lowermost stage is at least 10% lower in sludge-filtration resistance or pure-water permeation resistance than any other membrane units.

3. The multi-stage submerged type membrane separation device according to claim 1, wherein the membrane unit placed at the lowermost stage is greater in number of the flat sheet membrane elements installed therein than the any of the membrane units placed at stages higher than the membrane unit placed at the lowermost stage.

4. The multi-stage submerged type membrane separation device according to claim 1, wherein each of the membrane units has a permeate pipeline communicating therewith and sending permeate having passed through the separation membrane, and
the permeate pipeline communicating with the membrane unit placed at the lowermost stage in the membrane module is connected to the permeate pipeline communicating with the any of the membrane units placed at stages higher than the membrane unit placed at the lowermost stage.

5. The multi-stage submerged type membrane separation device according to claim 4, wherein a permeate flow rate in the membrane unit placed at the lowermost stage and a permeate flow rate in the any of the membrane units which is placed at a stage higher than the membrane unit placed at the lowermost stage and communicates with the permeate pipeline connected to the permeate pipeline communicating with the membrane unit placed at the lowermost stage are each controlled so that a transmembrane pressure difference of the membrane unit placed at the lowermost stage is almost equalized with a transmembrane pressure difference of the any of the membrane units.

6. The multi-stage submerged type membrane separation device according to claim 1, wherein each of the membrane units has a permeate pipeline communicating therewith and sending permeate having passed through the separation membrane, and
the device further comprises a flow rate control means capable of independently controlling a flow rate of permeate sent through the permeate pipeline communicating with the membrane unit placed at the lowermost stage in the membrane module and a flow rate of permeate sent through the permeate pipeline communicating with the any of the membrane units placed at a stage higher than the membrane unit placed at the lowermost stage.

7. A membrane separation method using a multi-stage submerged type membrane separation device which comprises: a membrane module having a plurality of membrane units stacked vertically in stages, in each of which a plurality of flat sheet membrane elements each having a sheet-shaped separation membrane are arranged; a water-to-be-treated storage tank in which water to be treated is stored and the membrane module is placed in a state of being submerged in the water to be treated; and an air diffuser installed beneath the membrane module, in which the membrane unit placed at the lowermost stage is lower in sludge-filtration resistance or pure-water permeation resistance than any of the membrane units placed at stages higher than the membrane unit placed at the lowermost stage.

8. The membrane separation method according to claim 7, wherein a flow rate of permeate passing through the separation membrane of the membrane unit placed at the lowermost stage in the membrane module is controlled so as to become lower than a flow rate of permeate passing through the separation membrane of the any of the membrane units placed at a stage higher than the membrane unit placed at the lowermost stage, and controlled so that a difference between these flow rates becomes 10% or below.
